(19) United States
(12) Patent Application Publication
(10) Pub. No.: US 2010/0277083 A1
(43) Pub. Date: Nov. 4, 2010

(54) LIGHTING DEVICE

(75) Inventors: Kiyoshi Nishimura, Yokosuka-shi (JP); Hirokazu Otake, Yokosuka-shi (JP); Tomohiro Sanpei, Yokosuka-shi (JP); Shuhei Matsuda, Yokosuka-shi (JP)

Correspondence Address: CHARLES N.J. RUGGIERO;OHLANDT, GREELEY, RUGGIERO & PERLE, L.L.P., 10th FLOOR, ONE LANDMARK SQUARE, STAMFORD, CT, 06901-2682, US

(73) Assignee: Toshiba Lighting & Technology Corporation

(21) Appl. No.: 12/835,149

(22) Filed: Jul. 13, 2010

Related U.S. Application Data
(63) Continuation of application No. PCT/JP2009/052802, filed on Feb. 18, 2009.

(30) Foreign Application Priority Data
Feb. 18, 2008 (JP) 2008-036398

(51) Int. Cl. H05B 37/02

(52) U.S. Cl. 315/185 R; 315/291; 315/294

(57) ABSTRACT

According to one embodiment, a lighting device includes a device board, a rectification device connected to a commercial power supply, a series LED circuit, and a transistor (current limiter) which limits a maximum current flowing through the series LED circuit. The series circuit mounted on the device board is configured by connecting in series a plurality of LED elements. Each of the LED elements lights when an output voltage of the rectification device is applied to the series circuit. A number of LED elements included in the series circuit is set in a manner that a voltage applied to the series LED circuit is 70 to 90% of the output voltage of the rectification device.

### CROSS REFERENCE TO RELATED APPLICATIONS

This is a Continuation Application of PCT Application No. PCT/JP2009/052802, filed Feb. 18, 2009, which was published under PCT Article 21(2) in Japanese.

This application is based upon and claims the benefit of priority from Japanese Patent Application No. 2008-036398, filed Feb. 18, 2008; the entire contents of which are incorporated herein by reference.

### FIELD

Embodiments described herein relate generally to a lighting device which causes a plurality of light emitting diode (LED) elements connected in series to emit light simultaneously.

### BACKGROUND

Jpn. Pat. Appln. KOKAI Publication No. 2005-100799 discloses an LED lighting device which is configured by connecting in series a plurality of LEDs mounted on a printed circuit board. In the LED lighting device, an end of a series circuit constituted by a plurality of LED elements is connected to an anode, and the other end thereof is connected to a cathode. The anode and cathode are both arranged at a side edge on one surface of the printed circuit board. When a direct current of 12 V is applied between these electrodes, the LED lighting device causes the LED elements to emit light simultaneously.

In conventional LED lighting devices, a voltage of 10 to 15 V is applied at present. For example, a voltage of 12 V is applied to the LED lighting device disclosed in Jpn. Pat. Appln. KOKAI Publication No. 2005-100799. If the applied voltage is thus low, circuit efficiency of a power supply device deteriorates considerably. For example, when the rated voltage of a power supply is 100 V, energy of only 10 to 15% of the power supply voltage is used. In addition, as the number of LED elements increases, the voltage applied to individual LED elements connected in series decreases. Therefore, when the applied voltage is low, it is hard for individual LED elements to emit light with high luminance.

The present invention has an object of providing a lighting device in which circuit efficiency and light emissive intensity can be improved.

A lighting device includes: a device board; a rectification device connected to a commercial power supply; a series LED circuit mounted on the device board and configured by connecting in series a plurality of LED elements; and a current limiter which is connected in series with the series LED circuit and limits a maximum current flowing through the series LED circuit, wherein an output of the rectification device is applied to a series circuit constituted by the series LED circuit and the current limiter, thereby to light each of the plurality of LED elements. In the lighting device as described above, according the invention of Claim 1, a number of the plurality of the LED elements is set in a manner that a voltage applied to the series LED circuit is 70 to 90% of an output voltage of the rectification device.

The present inventor measured light emissive efficiency and circuit efficiency while changing the number of LED elements constituting the series LED circuit. Specifically, circuits were respectively prepared by connecting in series different numbers of LED elements, where the different numbers corresponded respectively to numbers from 10 to 50. Further, a commercial power supply was applied to each of the series LED circuits in order to light the LED elements. Light emissive efficiency and circuit efficiency were measured at this time. Used LED elements most efficiently emitted light at a voltage of about 3 V when a direct current of 20 mA was made to flow. Such LED elements are frequently used at present.

A lighting control circuit for lighting the series LED circuits included a full-wave rectification device and a current limiter. The lighting control circuit rectifies a voltage of 100 V from the commercial power supply, and a maximum current of a rectified output thereof was limited by the current limiter. A voltage corresponding to the limited maximum current was applied to the series LED circuits.

FIG. 7 represents a result of measuring the light emissive efficiency and circuit efficiency. As is obvious from FIG. 7, the light emissive efficiency has a peak when the number of LED elements comprised in the series LED circuit is around 25. The light emissive efficiency decreases as the number of LED elements increases from this number causing the peak. This is because the voltage applied to each LED element decreases as the number of LED elements increases. When the applied voltage decreases, each of the LED elements cannot achieve light emission with high luminance. When the number of LED elements exceeds 36, the light emissive efficiency is smaller than 0.5 and cannot meet practically required light emissive efficiency any more. In the present description, the voltage applied to each of the LED elements is referred to as an LED lighting voltage.

The circuit efficiency has a peak when the number of LED elements comprised in the series LED circuit is around 39. This is because, as the number of LED elements increases toward the number causing the peak, loss due to heat production by transistors constituting the current limiter decreases.

Total efficiency obtained by multiplying the light emissive efficiency and the circuit efficiency has a peak when the number of LED elements comprised in the series LED circuit is around 33. Further, the total efficiency decreases more or less from the number causing the peak.

Suitable voltages to be applied to the series LED circuit in order to light individual LED elements at the LED lighting voltage of about 3 V, the number of which causes total efficiency of 0.54 or more, are written along the horizontal axis in the graph of FIG. 7.

As is apparent from FIG. 7, when the voltage applied to the series LED circuit is 80 V, the lighting device attains the highest total efficiency. Even within a voltage range of 70 to 90 V, the lighting device attains efficiency beyond 0.5.

If the number of LED elements is set to 25 to prioritize the light emissive efficiency, a suitable voltage is lower than 70 V. In this case, electric energy loss of 30% or more occurs unpreferably. Otherwise, if the number of LED elements is set to 39 to prioritize the circuit efficiency, a suitable voltage exceeds 100 V. In this case, the LED lighting voltage applied to each of the LED elements decreases even with the power supply voltage of 100 V, and the lighting device cannot obtain light emissive efficiency of 0.5 or more.

From consideration described above, according to the invention of Claim 1, the number of LED elements is determined in a manner that the voltage applied to the series LED circuit in which a plurality of LED elements are connected in series is 70 to 90% of the output voltage of the rectification device which rectifies the voltage of the commercial power supply.

Specifically, when the voltage of the commercial power supply is 100 V, as in the invention of Claim 2, the lighting device may set the number of LED elements comprised in the series circuit to 30 to 34. If the voltage of the commercial power supply is 200 V, the lighting device may set the number of LED elements comprised in the series circuit to 60 to 64.

The output voltage of the rectification device is, for example, 100±10 V, and the number of LED elements comprised in the series LED circuit is set to 30 to 34. In this case, obviously from FIG. 7, the lighting device achieves high circuit efficiency and low electric energy loss. Also, the lighting device achieves light emissive efficiency whose value is sufficiently high in practical use. Thus, the present invention can improve the circuit efficiency and light emissive efficiency of the lighting device.

According to the invention of Claim 3, the device board comprises a base made of metal, an insulating layer layered on the base, and a plurality of metal layers layered on the insulating layer, with the plurality of metal layers electrically isolated from each other. A plurality of LED element rows, each of which is constituted by a plurality of the LED elements connected in series with one another, are respectively mounted on the plurality of metal layers. The plurality of LED element rows and the plurality of metal layers are electrically connected to each other in a manner such that individual voltages which are applied to the plurality of LED element rows are respectively applied to the plurality of metal layers on which the plurality of LED element rows are mounted.

In the invention of Claim 3, the metal layers where LED element rows each constituted by a plurality of LED elements are mounted have a much larger area than the LED elements. Therefore, in addition to the function as a metal-made base, the metal layers function as a heat diffusion member for the LED elements. That is, heat which is produced by the LED element while the LED elements are lit spreads smoothly over the metal layers. Further, the heat is discharged from the metal layers to the metal-made base through the insulating layer. As a result, the lighting device can suppress decrease of the light emissive efficiency caused by excessive increase in temperature of each of the LED elements.

Also in the invention of Claim 3, the metal layers are respectively electrically connected to the LED element rows mounted on the metal layers. Therefore, during lighting, an electric potential is applied to each of the metal layers. When no potential is applied to any of the metal layers, the metal layers are influenced by electrical noise. The metal layers also serve as a noise radiation source because of antenna effects. According to the invention of Claim 3, such problems can be prevented.

Further in the invention of Claim 3, the metal layers do not form a single layer but are a plurality of separate layers electrically isolated from each other. Therefore, although a power supply voltage is applied to the series LED circuit, a maximum value of the power supply voltage is not applied to individual LED elements. If voltage differences between the LED elements and the metal layers and between the metal layers and the metal-made base decrease, defective sealing appears in a seal member which seals the LED elements. However, even when such defective sealing appears, electric isolation is maintained between the LED elements and the metal layers and accordingly between the metal layers and the metal-made base according to the invention of Claim 3. Therefore, predetermined withstand voltage performance is maintained. Accordingly, the lighting device provides excellent electrical safety.

In this case, the lighting device may set the number of LED elements in each of the LED element rows in a manner that a voltage applied to each of the LED element rows is 30 V or less, as in the invention of Claim 4. Specifically, the number of LED elements included in one LED element row is set to 2 to 10.

In addition, to ensure withstand voltage performance, the lighting device may set the number of LED elements included in each LED element row in a manner that a voltage difference between each adjacent two metal layers is 30 V or less, as in the invention of Claim 5.

The invention of Claim 5 can suppress occurrence of ion migration between each adjacent two metal layers. Ion migration is a phenomenon that, when a voltage is applied to two pieces of metal, metal ions move along an electrically conductive channel from one to the other of the pieces of metal. This phenomenon becomes more conspicuous as electric energy increase in accordance with increase of the voltage applied between the two pieces of metal increases. Therefore, if ion migration occurs between metal layers to which electric potentials are applied and if this phenomenon progresses, there is a risk that the lighting device causes deterioration of isolation and short-circuiting between the metal layers to which electric potentials are applied. If short-circuiting occurs, voltage differences increase between the LED elements and the metal layers and accordingly between the metal layers and the metal-made base. Reliability concerning a withstand voltage of the lighting device deteriorates. Ion migration is also referred to as electrochemical migration.

However, in the invention of Claim 5, the number of LED elements comprised in each of the LED element rows is set in a manner that a voltage applied between one and another ends of each of the LED element row is 30 V or less. Therefore, the lighting device can suppress a voltage difference between each adjacent two of metal layers to 30 V or less. If the voltage difference between each adjacent two of the metal layers can be suppressed to 30 V or less, ion migration does not occur between metal layers to which electric potentials are applied. Further, electric isolation is maintained between the LED elements and the metal layers and accordingly between the metal layers and the metal-made base. Predetermined withstand voltage performance can be thereby ensured. Accordingly, the lighting device provides excellent electrical safety.

In the invention of Claim 6, the number of LED elements is set in a manner that a forward LED element voltage applied to the series LED circuit is 70 to 90% of a rated input voltage of the commercial power supply.

The forward LED element voltage is a peak value of a voltage which is produced in the series LED circuit when the maximum current limited by the current limiter is made to flow.

The present inventor measured light emissive efficiency and circuit efficiency while changing the number of LED elements constituting a series LED circuit. Specifically, circuits were respectively prepared by connecting in series different numbers of LED elements, where the different numbers corresponded respectively to numbers from 10 to 50. Further, a commercial power supply was applied to each of the series LED circuits in order to light the LED elements. Light emissive efficiency and circuit efficiency were measured at this time. Used LED elements most efficiently emitted light at a voltage of about 3 V when a direct current of 20 mA was made to flow. Such LED elements are frequently used at present.

The lighting control circuit which lights the series LED circuits includes a full-wave rectification device and a current limiter. The lighting control circuit rectifies the power supply voltage by the full-wave rectification device, and limits a maximum current of a rectified output thereof by the current limiter. The lighting control circuit applies a voltage corresponding to the maximum current, to the series LED circuits.

Although the rated input voltage of the commercial power supply is 100 V, an effective value of the rated input voltage ordinarily varies within a range of ±10 V, where voltage fluctuation is taken into consideration. Hence, the present inventor used three different voltages of 90, 100, and 110 V as power supply voltages. The maximum current limited by the current limiter was set to 30 mA.

FIGS. 8A and 8B represent results of measuring circuit efficiency and light emissive efficiency. FIG. 8C represents a result of calculating total efficiency by multiplying the light emissive efficiency and the circuit efficiency. In FIGS. 8A, 8B, and 8C, the horizontal axis represents a ratio (%) of a forward LED element voltage Vf to the rated input voltage of the commercial power supply.

Obviously from FIG. 8C, higher total efficiency than 0.5 can be obtained in any case of using 90, 100, and 110 V as the power supply voltages, when the aforementioned ratio is within a range of 70 to 90%. Therefore, the circuit efficiency and light emissive intensity of the lighting device can be improved, according to the invention of Claim 6 in which the number of LED elements for each of the series LED circuits is set in a manner that the forward LED element voltage Vf applied to the series LED circuits is 70 to 90% of the rated input voltage of the commercial power supply.

### BRIEF DESCRIPTION OF THE DRAWINGS

FIG. 1A is a substantial plan view illustrating a device board according to an embodiment, except for a seal member comprised in the board;

FIG. 1B is an enlarged view illustrating a series-circuit mount area in the device board in FIG. 1A;

FIG. 2 is a more enlarged view illustrating the series-circuit mount area in FIG. 1B;

FIG. 3A is a cross-sectional view illustrating the device board along line X-X in FIG. 1B;

FIG. 3B is a cross-sectional view illustrating the device board along line Y-Y in FIG. 1B;

FIG. 3C is a cross-sectional view of the device board along line Z-Z in FIG. 1C;

FIG. 4 depicts lighting control circuits for controlling lighting of the lighting device;

FIG. 5A represents an alternating current voltage waveform of a commercial power supply in the lighting control circuits in FIG. 4;

FIG. 5B represents a voltage waveform smoothed by a rectification device in the lighting control circuits in FIG. 4;

FIG. 5C represents a voltage waveform with a peak value controlled by limiting a maximum current by a transistor in the lighting control circuits in FIG. 4;

FIG. 6 is a cross-sectional view illustrating a bulb-type LED lamp as a lighting device according to the embodiment;

FIG. 7 is a graph representing relationships among a number of LED elements, a voltage applied to the series circuit, and efficiency;

FIG. 8A is a graph representing a relationship between a ratio of a forward LED element voltage to a rated input voltage and circuit efficiency, when three voltages of 90, 100, and 110 V were used for the commercial power supply;

FIG. 8B is a graph representing a relationship between the ratio of the forward LED element voltage to the rated input voltage and light emissive efficiency, when the three voltages of 90, 100, and 110 V were used for the commercial power supply;

FIG. 8C is a graph representing a relationship between the ratio of the forward LED element voltage to the rated input voltage and total emissive efficiency, when the three voltages of 90, 100, and 110 V were used for the commercial power supply;

FIG. 9A is a front view of a part of the series-circuit mount area of the lighting device in FIG. 1, illustrating a modification to electric connections between metal layers and LED element rows mounted on other metal layers adjacent to the foregoing metal layers;

FIG. 9B is a front view illustrating another part of the modification in FIG. 9A;

FIG. 10A is a waveform chart of a current flowing through a series LED circuit and a forward LED element voltage, where the number of LED elements is set to 25;

FIG. 10B is a waveform chart of a current flowing through a series LED circuit and a forward LED element voltage, where the number of LED elements is set to 30; and

FIG. 10C is a waveform chart of a current flowing through a series LED circuit and a forward LED element voltage, where the number of LED elements is set to 35.

### DETAILED DESCRIPTION

### First Embodiment

In general, according to one embodiment, the first embodiment employs a bulb-type LED lamp as a lighting device 1.

The lighting device 1 comprises a device board 21 and a circuit board 51. The device board 21 is attached to an end side of a thermal radiator 52. A globe 53 is also attached to the end side of the thermal radiator 52. The circuit board 51 is contained in a container case 54 attached to the other end side of the thermal radiator 52. A metal base 55 is attached to the container case 54. The device board 21 is electrically connected to the circuit board 51 by a wire (unillustrated) which penetrates a wire hole 56 cut in the thermal radiator 52 and the container case 54.

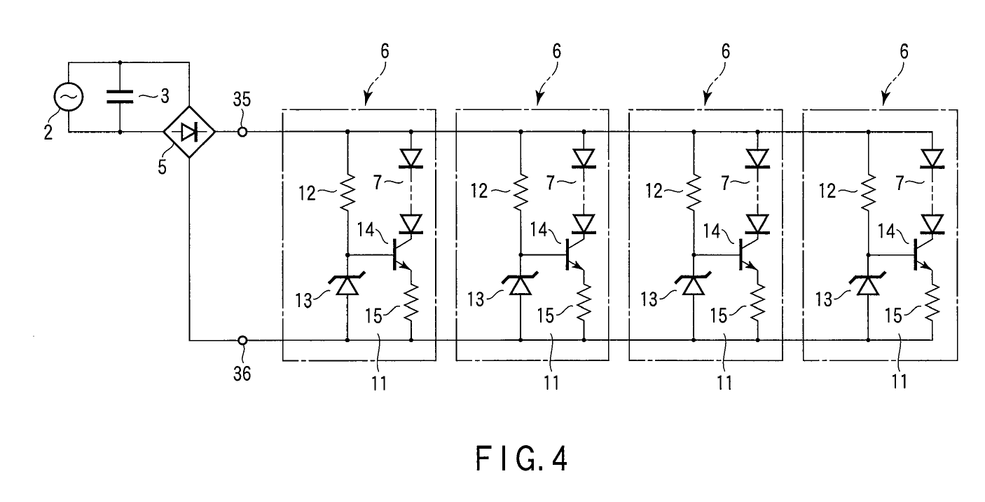

FIG. 4 depicts lighting control circuits for controlling lighting of the lighting device 1 by supplying power from a commercial power supply 2. The lighting control circuits are mounted to the device board 21 and the circuit board 51.

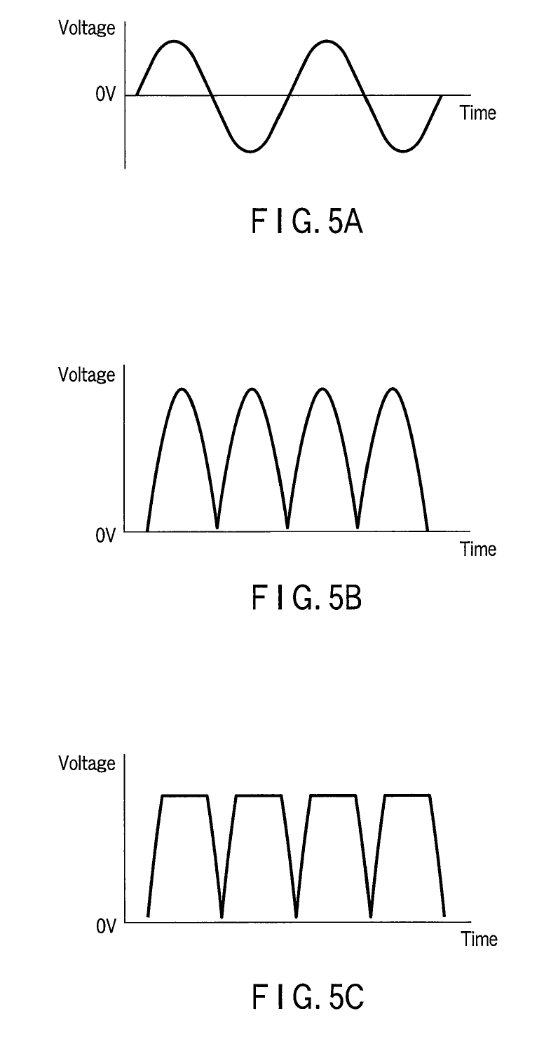

The commercial power supply 2 is an alternating-current power supply which has, for example, a power supply voltage of 100 V. FIG. 5A depicts an alternating-current voltage waveform of the commercial power supply 2.

The alternating current voltage of the commercial power supply 2 is smoothed by a smoothing capacitor 3, and is then supplied to a rectification device 5. The rectification device 5 is a full-wave rectifier and performs full-wave rectification on the smoothed alternating current voltage. FIG. 5B depicts a rectified waveform.

Four lighting control circuits 6 are connected in parallel to an anode terminal 35 and cathode terminals 36 which are output ends of the rectification device 5. An output voltage of the rectification device 5 is applied simultaneously to the lighting control circuits 6. The lighting control circuits 6 each comprise a series LED circuit 7 and a current limiting circuit 11.

The series LED circuit 7 connects LED elements in series. The current limiting circuit 11 comprises a resistor 12, a Zener diode 13, and transistor 14 and resistor 15. The Zener diode 13 is connected in series to a resistor 12. A base of the transistor 14 is connected to a contact point to the resistor 12 and Zener diode 13. The resistor 15 is connected to a collector of the transistor 14. The series LED circuit 7 is connected to an emitter of the transistor 14.

Therefore, the transistor 14 is connected in series to the series LED circuit 7. The transistor 14 as a current limiter comprised in the current limiting circuit 11 limits a maximum current which flows through the series LED circuit 7. FIG. 5C depicts a voltage waveform with a peak value controlled by limiting the maximum current by the transistor 14.

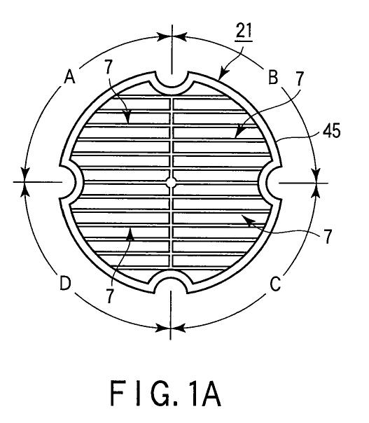

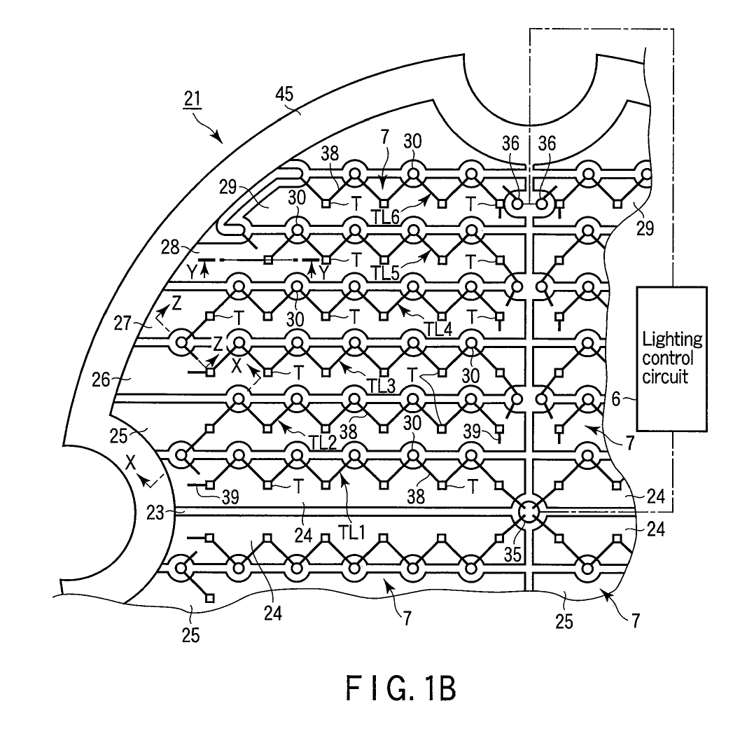

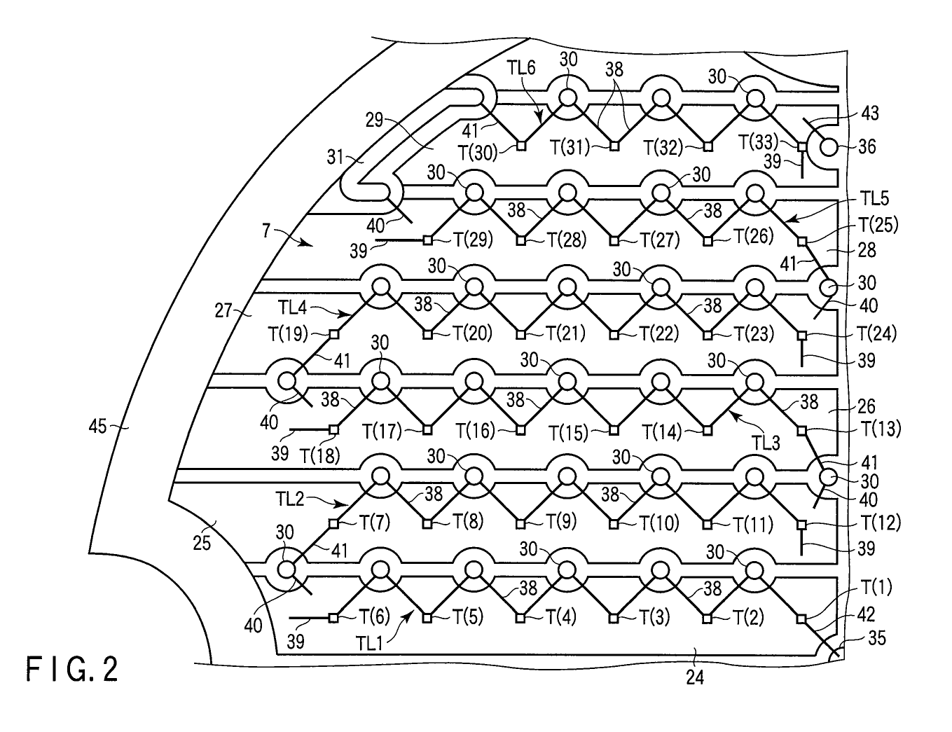

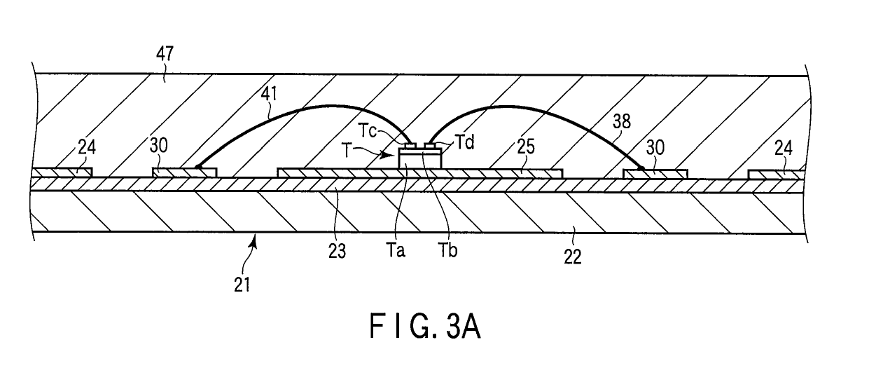

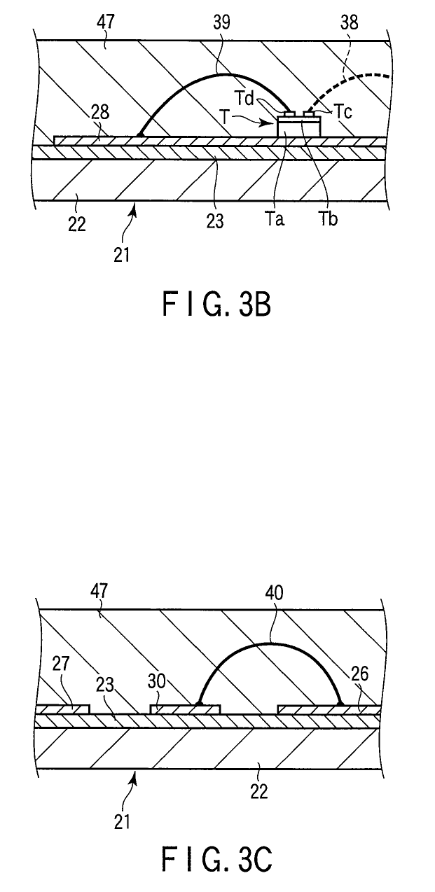

The device board 21 is illustrated in FIGS. 1A, 1B, 2, 3A, 3B, and 3C. FIG. 1A is a plan view of the device board 21. A seal member comprised in the device board 21 is omitted here from. FIG. 1B is an enlarged view of a series-circuit mount area in the device board 21 illustrated in FIG. 1A. FIG. 2 is a more enlarged view of the series-circuit mount area in FIG. 1B. FIG. 3A is a cross-sectional view of the device board 21 along line X-X in FIG. 1B. FIG. 3B is a cross-sectional view of the device board 21 along line Y-Y in FIG. 1B. FIG. 3C is a cross-sectional view of the device board 21 along line Z-Z in FIG. 1C.

The device board 21 comprises a base 22, an insulating layer 23, a plurality of metal layers, e.g., first to sixth metal layers 24 to 29, a plurality of relay pads 30, an anode terminal 35, and cathode terminals 36.

The base 22 is formed of a metal plate such as an aluminum plate in order to radiate heat produced by LED elements T, described later, externally. The insulating layer 23 is layered on a whole surface of the base 22 forming a front surface thereof. A material and a thickness of the insulating layer 23 are chosen to attain high thermal conductivity of 6 W/K.

Circuit components which constitute, respectively, the smoothing capacitor 3, rectification device 5, and current limiting circuit 11 are attached to the base 22. The circuit components are internally included in the base 22. Alternatively, circuit components are attached to and exposed on a back surface of the base 22.

The device board 21 is divided equally into four areas A to D each of which occupies an angular range of 90 degrees about the center of the device board 21, for example, as illustrated in FIG. 1A. Each of areas A to D is provided with the first to sixth metal layers 24 to 29 and a plurality of relay pads 30.

As represented in FIGS. 3A, 3B, and 3C, the first to sixth metal layers 24 to 29 are each layered on the insulating layer 23. The first to sixth metal layers 24 to 29 are provided in parallel at intervals maintained between each other, as represented in FIGS. 1B and 2. Therefore, the first to sixth metal layers 24 to 29 are electrically isolated from each other. As represented in FIG. 2, a relay metal layer 31 is provided near an end part of the sixth metal layer 29 in its length directions.

As represented in FIG. 1B, the relay pads 30 are provided so as to respectively correspond to the first to sixth metal layers 24 to 29. Specifically, the relay pads 30 are respectively provided at intervals along one of the edges of the first to sixth metal layers 24 to 29 extending in length directions of themselves. The relay pads 30 are provided apart from the metal layers 24 to 29. The number of relay pads 30 arranged beside each of the metal layers 24 to 29 is equal to the number of LED elements T described later which are mounted on the each of the metal layers 24 to 29.

The anode terminal 35 as another output end of the rectification device 5 is provided in a center part of the device board 21. The anode terminal 35 is provided in common to the series LED circuits 7. The cathode terminals 36 as another output end of the rectification device 5 are provided in peripheral parts of the device board 21. The cathode terminals 36 are respectively provided for individual series LED circuits 7.

The metal layers 24 to 29, relay pads 30, relay metal layer 31, anode terminal 35, and cathode terminals 36 are each formed by plating a base layer made of copper with nickel and gold in this order.

The LED elements T are mounted on each of the metal layers 24 to 29. In order to distinguish individual LED elements T from each other, the reference symbol T indicating each LED element is added with a bracketed number. As represented in FIGS. 3A and 3B, a semiconductor light emitting layer Tb is provided on a surface of an LED element substrate Ta, in each of the LED terminals T. Also in each of the LED elements T, an anode Tc and a cathode Td are provided in a side of the semiconductor light emitting layer Tb.

The LED element substrate Ta is made of a light-transmissible insulating material, for example, such as sapphire which is 100 μm thick. When the semiconductor light emitting layer Tb is electrically conducted, the layer Tb radiates mainly blue light. Such LED elements T are named blue light emitting diodes. Since these LED elements T are mounted on each of the metal layers 24 to 29, the other surface of the LED element substrate Ta opposite to the aforementioned one surface thereof is bonded to the metal layers 24 to 29 by a transparent die-bond material. The die-bond material uses a transparent silicone paste.

The series LED circuits 7 each of which is constituted by connecting a plurality of LED elements T in series are provided on each of areas A to D. These series circuits 7 each comprise LED element rows TL1 to TL6 in each of which a plurality of LED elements T are connected in series. The series LED circuits 7 are each formed by further connecting LED elements TL1 to TL6.

LED element rows TL1 to TL6 will now be described specifically. In the present embodiment, the anode Tc and cathode Td of each of a plurality of LED elements T mounted on one metal layer are respectively connected to two adjacent relay pads 30 at positions corresponding to the LED element T. Connections of the anodes Tc and cathodes Td to the relay pads 30 are made by using bonding wires 38 formed of thin gold lines. Through such connections, the plurality of LED elements T are connected in series through the relay pads 30 arranged along each metal layer. Thus, LED element rows TL1 to TL6 are respectively formed on the metal layers 24 to 29.

Alternatively, LED element rows TL1 to TL6 may be constituted by directly connecting the anode Tc and cathode Td of each adjacent two LED elements to each other by a bonding wire 38. In this case, the relay pads 30 may be omitted from the lighting device 1.

Alternatively, the LED elements T need not be of a double wire connection type as described above. For example, the LED elements T may be of a single wire connection type in which LED element electrodes are respectively provided on two surface parts of each of the LED elements. For the single wire connection type, the LED elements are each mounted on a wiring pattern. In this case, LED element rows TL1 to TL6 are each constituted by connecting an LED element electrode on an upper surface of each of the LED elements to another wiring pattern which mounts an adjacent LED element, by the bonding wires 38.

The cathodes Td of LED elements T positioned at the other ends of LED element rows TL1 to TL6 are connected to the metal layers 24 to 29 on which are mounted LED element rows TL1 to TL6, respectively. In this case, bonding wires 39 are used for connections. As a result, LED element rows TL1 to TL6 are connected to the metal layers 24 to 29 on which are respectively mounted LED element rows TL1 to TL6. Thus, voltages between the ends of LED element rows TL1 to TL6 in the side of the power supply and the other ends thereof in opposite sides, or namely forward LED element voltages, are respectively applied independently to the metal layers 24 to 29 corresponding to LED element rows TL1 to TL6.

In FIG. 2, the ends of LED element rows TL1 to TL6 in the side of the power supply indicate specifically: an LED element T(1) positioned at the end of LED element row TL1; an LED element T(7) positioned at the end of LED element row TL2; an LED element T(13) positioned at the end of LED element row TL3; an LED element T(19) positioned at the end of LED element row TL4; an LED element T(25) positioned at the end of LED element row TL5; and an LED element T(30) positioned at the end of LED element row TL6.

Also in FIG. 2, the other ends of LED element rows TL1 to TL6 in the side opposite to the side of the power supply indicate specifically: an LED element T(6) positioned at the other end of LED element row TL1; an LED element T(12) positioned at the other end of LED element row TL2; an LED element T(18) positioned at the other end of LED element row TL3; an LED element T(24) positioned at the other end of LED element row TL4; an LED element T(29) positioned at the other end of LED element row TL5; and an LED element T(33) positioned at the other end of LED element row TL6.

Next, series connection between LED element rows TL1 to TL6 will be described. In the present embodiment, end parts of LED element rows TL1 to TL6, which form the aforementioned other ends opposite to the ends of LED element rows TL1 to TL5 in the side of the power supply, are connected to end parts of adjacent LED element rows TL2 to TL6, which form the aforementioned other ends in the same side as well. To connect these end parts, bonding wires 40 and 41 and relay pads 30 or metal relay layers 31 positioned at the end parts in the same side are used. Through such connections, LED element rows TL1 to TL6 are connected in series to form a series LED circuit 7. In these connections, the bonding wire 40 connects the metal layers 24 to 29 to the pads 30 or relay metal layer 31. The bonding wire 41 connects the relay pads 30 or relay metal layer 31 to any of the LED elements T(7), T(13), T(19), T(25), and T(30).

The LED element T(1) provided in the side of the power supply at an end of each of the series LED circuits 7, which are configured as described above, is connected to the anode terminal 35 through a bonding wire 42. The LED element T(33) provided at the other end of each of the series LED circuits 7, opposite to the aforementioned end, is connected to one of the cathode terminals 36 through a bonding wire 43.

The number of LED elements T comprised in each of the series LED circuits 7 is set in a manner that a voltage applied to each of the series LED circuits 7 is 70 to 90% of an output voltage of the rectification device 5. In the present embodiment in which the output voltage of the rectification device 5 obtained by rectifying the power supply voltage 100 V, the number of LED elements T comprised in one series LED circuit 7 may be set within a range of 30 to 34. FIG. 2 illustrates an example of 33 LED elements T for each series LED circuit.

To the 33 LED elements T, the voltage is distributed in a manner such that a voltage of 30 V or less is applied to LED element rows TL1 to TL6 and the voltage difference between each adjacent two metal layers 24 to 29 is also 30 V or less. In the present embodiment in which the output voltage of the rectification device 5 is 100 V, the number of LED elements T mounted on each of LED element rows TL1 to TL6 is selected from a range of 2 to 10. Specifically, as illustrated in FIG. 2, six LED elements T are mounted on each of the metal layers 24 to 27, to form LED element rows TL1 to TL4. Five LED elements T are mounted on the metal layer 28, to form LED element row TL5. Four LED elements T are mounted on the metal layer 29, to form LED element row TL6.

A frame 45 is formed of an electrically insulating material such as synthetic resin into a shape which fits a shape of the device board 21. The frame 45 is fixed to peripheral parts of a surface of the device board 21 where the aforementioned series LED circuits 7 are mounted, as illustrated in FIG. 1A. Each of the series LED circuits 7 is positioned inside the frame 45. The frame 45 is preferably formed of, for example, white synthetic resin so that light can be reflected on an inner surface of the frame 45.

A seal member 47 is injected inside the frame 45 and cured by heat treatment. The seal member 47 embeds and seals each of the series LED circuits 7 and metal layers 24 to 29 in itself. The seal member 47 is made of a light-transmissible material such as transparent silicone resin, and a fluorescent material (unillustrated) is mixed in the light-transmissible material. The fluorescent material is mixed, preferably diffused substantially uniformly in the seal member 47. Since the LED elements T emit light in blue, the present embodiment uses a YAG fluorescent material which is excited by the blue light and thereby radiates yellow light.

In the lighting device 1 configured as described above, the output voltage obtained by rectifying the power supply voltage of 100 V through the rectification device 5 is applied to each of the lighting control circuits 6. In the lighting control circuits 6, the 33 LED elements T comprised in each of the series LED circuits 7 light simultaneously. On lighting, blue light emitted from each of the LED elements T partially transmits through the seal member 47 without colliding with the fluorescent material. On the other side, when the blue light collides with the fluorescent material, the fluorescent material is then excited and emits yellow light. The yellow light transmits through the seal member 47. Accordingly, the lighting device 1 emits white light toward an illumination target, as a result of mixing light of two colors which are complementary to each other.

When the white light is produced, each of the LED elements T produces heat. The produced heat transfers to the metal layers 24 to 29 through the LED element substrate Ta.

Each of the metal layers 24 to 29 where the LED elements T are mounted has a much larger area than each of the LED elements T. Therefore, the metal layers 24 to 29 function as a heat spreader which diffuses heat. That is, while each of the LED elements T is lit, heat transferred from each of the LED elements T to the metal layers 24 to 29 is rapidly diffused over the whole areas of the metal layers 24 to 29. The diffused heat further transfers to the whole area of the base 22 of the device board 21 through an insulating layer 23 of the device board 21. The heat transferred to the base 22 is discharged outside the lighting device 1 because of the heat spreader function of the base 22. Thus, the heat produced by each of the LED elements T is rapidly discharged from the based 22. Accordingly, the lighting device 1 can suppress decrease of light emissive efficiency caused by increase in temperature of each of the LED elements T.

In the lighting device 1, as described previously, the number of LED elements is set to 33 in a manner that the voltage applied to each of the series LED circuits 7 is 70 to 90% of the output voltage of the rectification device 5. As a preferable example, each of the plurality of LED elements T connected in series lights at substantially 3 V.

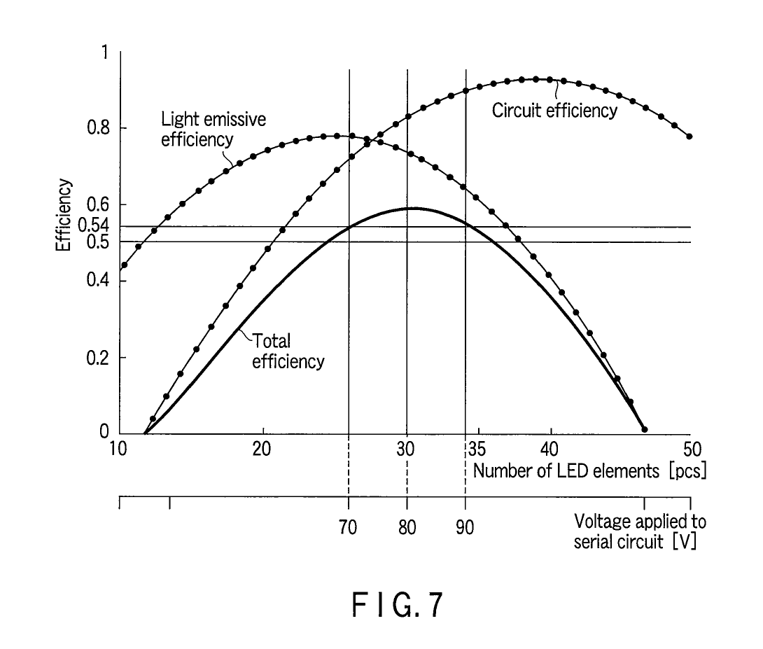

Therefore, the lighting device 1 can improve circuit efficiency and light emissive intensity. That is, the voltage of 70 to 90% of the output voltage of the rectification device 5 is applied to each of the series LED circuits 7. Even when the voltage drops most in the lighting device 1, the lighting device 1 suffers less electric energy loss relative to the power supply voltage of 100 V. Accordingly, as is obvious from a graph in FIG. 7, the lighting device 1 provides excellent circuit efficiency. Also obviously from the graph in FIG. 7, the lighting device 1 can attain higher light emissive efficiency than 0.54 within a range in which the output voltage of 70 to 90% of the rectification device 5 is applied to each of the series LED circuits 7.

Further, the same electric potential as applied between two ends of each of LED element rows TL1 to TL6 mounted on the metal layers 24 to 29 is applied through the bonding wires 40 to each of the metal layers 24 to 29, which diffuse heat produced by the LED elements during lighting as described above. An intermediate electric potential in the middle of LED element rows can be respectively applied to the metal layers. Therefore, troubles can be prevented from occurring when no voltage is applied to the metal layers 24 to 29 and the electric potential is accordingly not fixed. That is, the metal layers 24 to 29 are not influenced by electric noise or do not become a noise radiation source because of antenna effects.

The lighting device 1 is lit by applying the power supply voltage of 100 V to each of the lighting control circuits 6. The lighting control circuits 6 are each constituted by connecting in series LED element rows TL1 to TL6. However, as described previously, the power supply voltage of 100 V is not directly applied between individual LED elements T constituting the lighting control circuits 6 and the metal layers 24 to 29 where the LED elements T are mounted.

The metal layers 24 to 29 do not form a single layer prepared for each one of the series LED circuit 7. The metal layers 24 to 29 are a plurality of separate layers and are electrically isolated from each other. Voltages for LED element rows mounted on the metal layers 24 to 29 are respectively applied to the metal layers 24 to 29. Specifically, the metal layer 24 has an electric potential of 18 V. Each of the metal layers 25 to 27 has an electric potential of 15V. The metal layer 28 has an electric potential of 12 V, and the metal layer 29 has an electric potential of 9 V.

Six LED elements T(1) to T(6) each of which is lit at a voltage of substantially 3 V are mounted on the metal layer 24. Six LED elements T(7) to T(12), T(13) to T(18), as well as the T(19) to T(24), which are the same LED elements as above, are respectively mounted on the metal layers 25 to 27. Five LED elements T(25) to T(29), which are also the same LED elements as above, are mounted on the metal layer 28. Four LED elements T(30) to T(33), which are also the same LED elements as above, are mounted on the metal layer 29.

Thus, voltages of the individual LED element rows are respectively applied to the metal layers 24 to 29, and voltage differences between the LED elements T and the metal layers 24 to 29 are therefore reduced. Therefore, even when the lighting device 1 causes defective sealing, e.g., even when the seal member 47 peels off, the voltage of 100 V is applied neither between the LED elements T and the metal layers 24 to 29 nor between the metal layers 24 to 29 and the base 22. Accordingly, electric isolation is maintained between the LED elements T and the metal layers 24 to 29 and between the metal layers 24 to 29 and the base 22, and predetermined withstand voltage performance can be ensured. Thus, the lighting device 1 provides excellent electrical safety.

Further, in the present embodiment, withstand voltage performance is ensured for each LED element T by setting the electric potentials of the metal layers 24 to 29 to 30 V or less. Accordingly, in the lighting device 1, voltage differences between the metal layers 24 to 29 can be set to 30 V or less. Specifically, an electric potential difference between the metal layers 24 and 25 could be suppressed to 3 V, and electric potentials between the metal layers 25 to 27 could be suppressed to 3 V. An electric potential between the metal layers 27 and 28 could be suppressed to 3 V, and an electric potential difference between the metal layers 28 and 29 could be suppressed to 3 V. In this manner, occurrence of ion migration is suppressed, between the metal layers 24 to 29 to which electric potentials are applied. As a result, risks of causing deterioration of isolation and short-circuiting between the LED element T and the metal layers 24 to 29 can be eliminated. Therefore, electric isolation is maintained between the LED elements T and the metal layers 24 to 29, and predetermined withstand voltage performance is ensured. The lighting device 1 therefore provides extremely high electrical safety.

In the present embodiment, relay convex parts 30a may be provided to integrally protrude from one end parts of the metal layers 24 to 29 in length directions thereof, as represented in FIGS. 9A and 9B, in place of the relay pads provided near the aforementioned other ends of LED element rows TL1 to TL6, which are opposite to the ends thereof in the side of the power supply.

### Second Embodiment

In the first embodiment, the number of LED elements T comprised in each series LED circuit 7 is set in a manner that the voltage applied to each of the series circuits 7 through the rectification device 5 is 70 to 90% of the output voltage of the commercial power supply 2. This result depends on fluctuation of the power supply voltage. That is, the voltage of the commercial power supply 2 varies within a range of 10%, in general. For example, when a rated input voltage is 100 V from an alternating current power supply, an effective value of the input voltage is ordinarily 100±10 V, where voltage fluctuation is taken into consideration. That is, the effective value varies between 90 and 110 V.

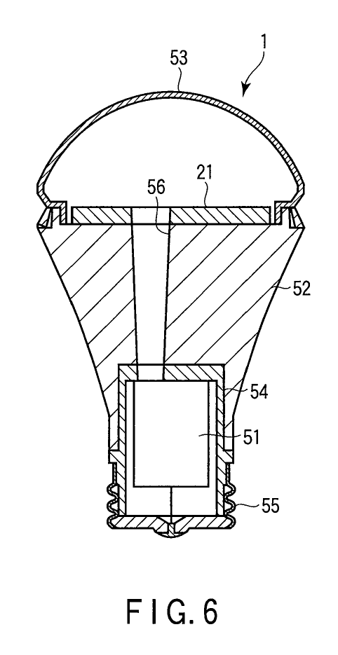

Fluctuation of the power supply voltage is taken into consideration in the second embodiment. Also in the second embodiment, a bulb-type LED lamp as illustrated in FIG. 6 is employed as a lighting device 1. Accordingly, FIGS. 1A, 1B, 2, 3A, 3B, 3C, 4, 5A, 5B, and 5C common to the first embodiment are also referred to in the second embodiment.

When the power supply voltage varies, a current flowing through each of the series LED circuits 7 varies. A maximum value of the current is limited to a constant value by a current limiting circuit 11.

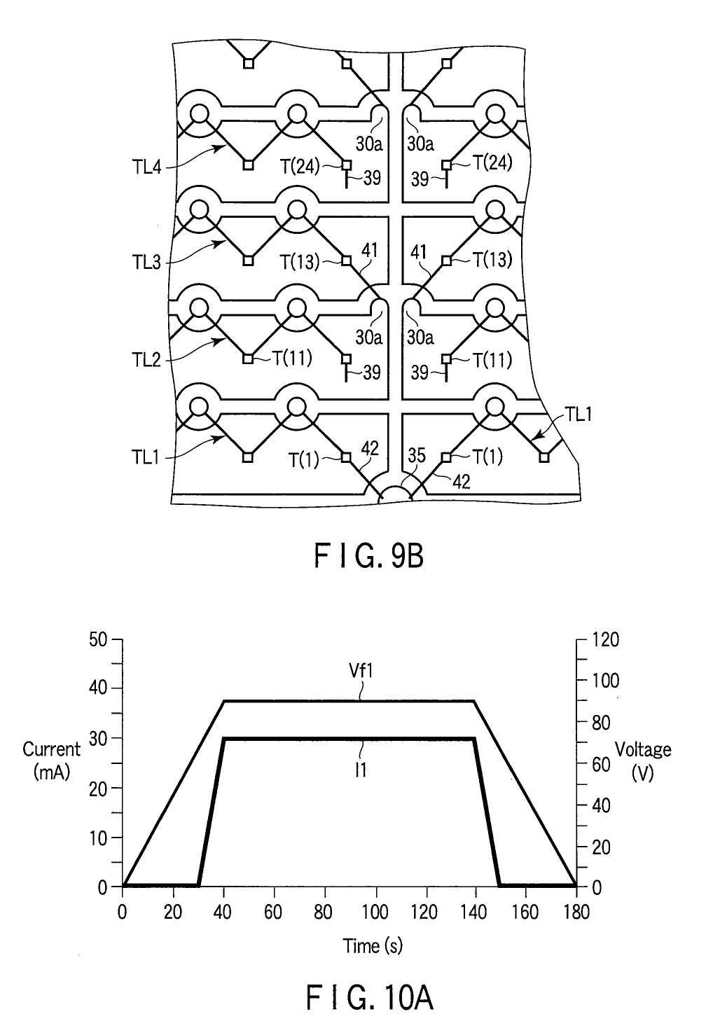

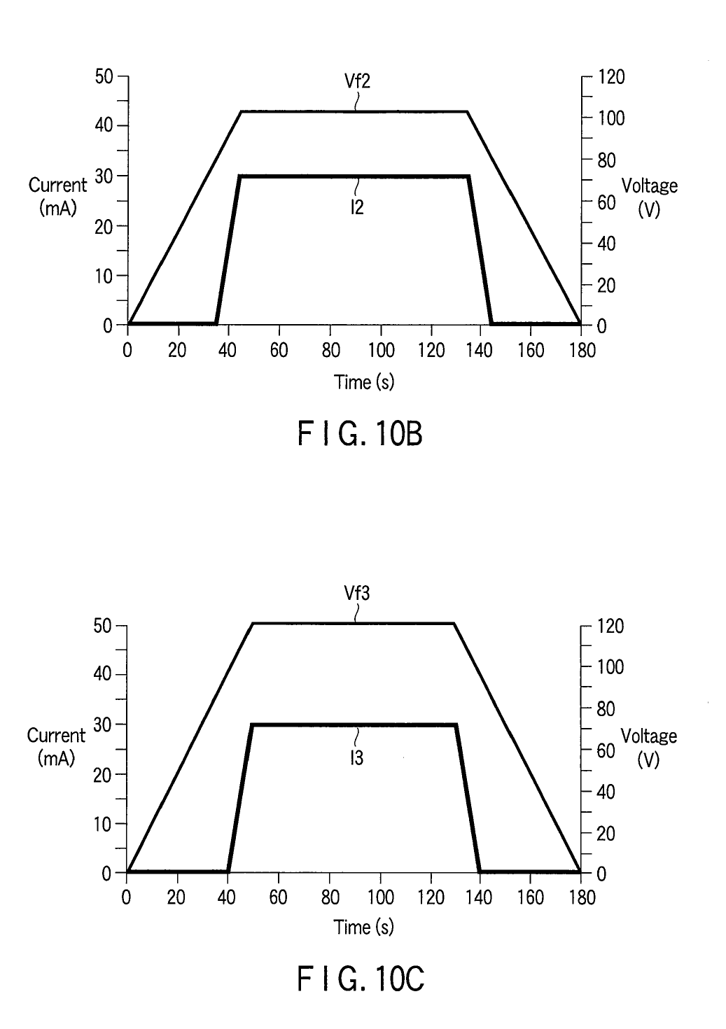

In the second embodiment, a maximum current which flows through each of the series LED circuits 7 is set to 30 mA. Correspondence between a current I1 which flows through each of the series circuits 7 and a forward LED element voltage Vf1 is represented in FIG. 10A, where the number of LED elements for each series LED circuit 7 is set to 25. Correspondence between a current I2 which flows through each of the series circuits 7 and a forward LED element voltage Vf2 is represented in FIG. 10B, where the number of LED elements for each series LED circuit 7 is set to 30. Correspondence between a current I3 which flows through each of the series circuits 7 and a forward LED element voltage Vf3 is represented in FIG. 10C, where the number of LED elements for each series LED circuit 7 is set to 35. In FIGS. 10A, 10B, and 10C, the horizontal axis represents time. The left vertical axis represents a current, and the right vertical axis represents a voltage.

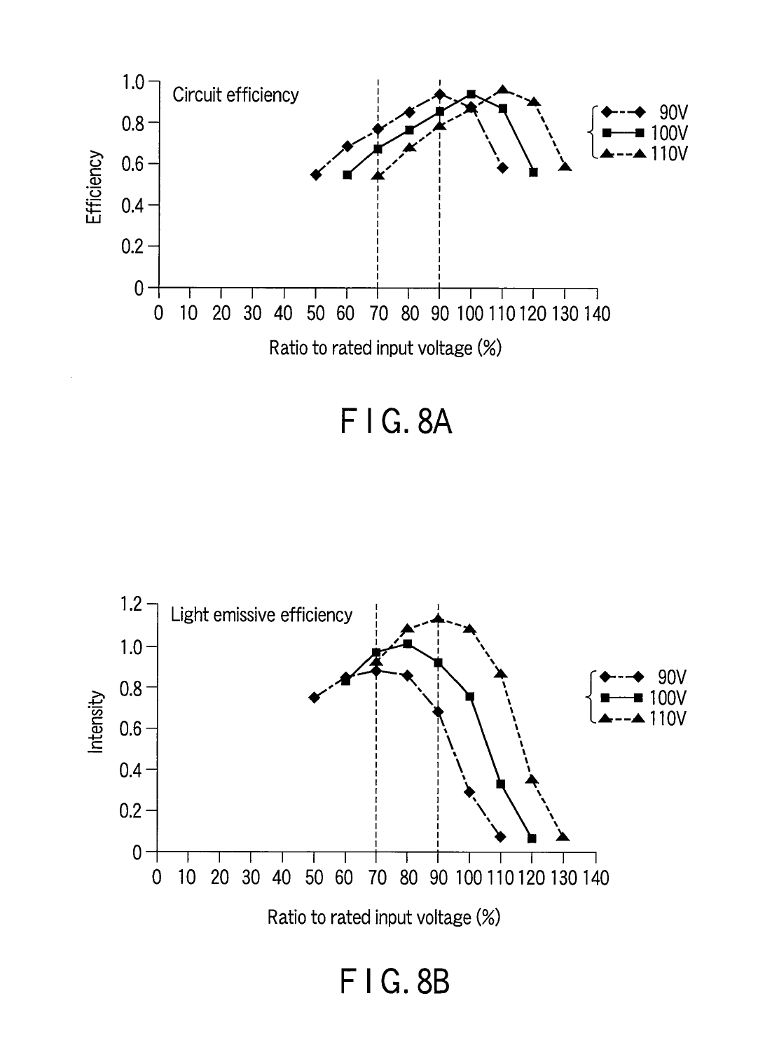

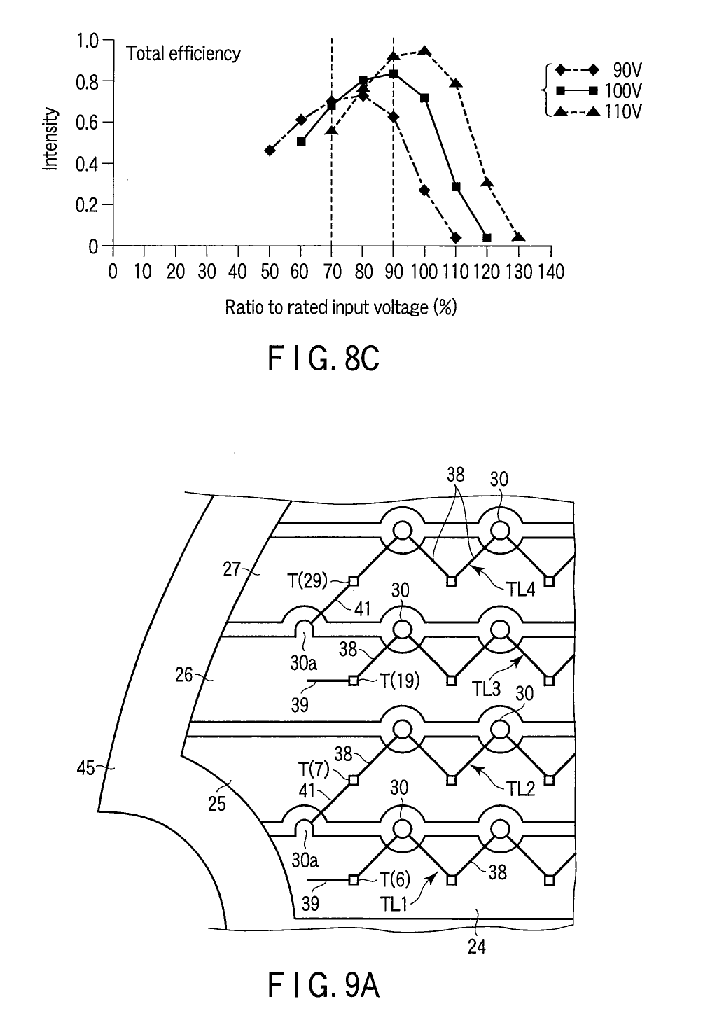

When the maximum current flowing through each of the series LED circuits 7 is constant, circuit efficiency of each of the series LED circuits 7 improves as the number of LED elements forming each of the circuits increases. However, as can be seen from FIGS. 8A, 8B and 8C, and 10A, 10B and 10C, when the maximum current flowing through each of the series LED circuits 7 is constant, the forward LED element voltage Vf increases as the number of LED elements for each of the circuits increases. Further, when the voltage Vf exceeds the power supply voltage, light emissive efficiency of each of the LED elements then decreases, in the lighting device 1.

In the second embodiment, the number of LED elements comprised in each of the series LED circuits 7 is set in a manner that a ratio of the forward LED element voltage Vf to the rated input voltage of 100 V of the commercial power supply 2 is 70 to 90%. In this manner, as represented in FIG. 8A, when the ratio to the rated input voltage of the commercial power supply 2 is between 70 and 90%, the circuit efficiency is 0.5% or more and tends to increase in any cases of the power supply voltages of 90, 100, and 110 V. Therefore, even when the power supply voltage varies, the circuit efficiency is excellent.

Also when the ratio to the rated input voltage of the commercial power supply 2 is between 70 and 90%, the range of 0.5% or more can be maintained although light emissive intensity decreases from near a peak value in case of the power supply voltage of 90 V, as represented in FIG. 8B. In case of 100 V, a range of 0.6% or more can be maintained including the peak value of the light emissive intensity. In case of 110 V, preferably, the light emissive intensity increases to near the peak value while the light emissive intensity is maintained at 0.6% or more. Also between 70 and 90%, an area where the light emissive intensity extremely decreases is not included, in any cases of the power supply voltages of 90, 100, and 110 V. Therefore, the light emissive intensity can attain a high value.

Further, higher total efficiency than 0.5 can be obtained in any cases of 90, 100, and 110 V when the ratio to the rated input voltage of the commercial power supply 2 is 70 to 90%, as represented in FIG. 8C. Therefore, the circuit efficiency and light emissive intensity of the lighting device 1 can be improved by setting the number of LED elements for each of the series LED circuits 7 in a manner that the forward LED element voltage Vf applied to each of the series LED circuits 7 is 70 to 90% of the rated input voltage of the commercial power supply 2.

The present invention is not limited to the above embodiment.

For example, the rated input voltage of the commercial power supply which is set to 100 V in the above embodiment is not limited to this voltage value. For example, the present invention is applicable even when a commercial power supply having any of various rated input voltages such as 120, 200, 220, and 230 V is used.

Further, the present invention is applicable even when a lighting control circuit in which a capacitor having small capacitance of 0.1 μF or less is inserted between output terminals of the rectification device 5 is used as a prevention against external noise.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting device comprising:
a device board;
a rectification device connected to a commercial power supply;
a series LED circuit mounted on the device board and configured by connecting in series a plurality of LED elements; and
a current limiter which is connected in series with the series LED circuit and limits a maximum current flowing through the series LED circuit, wherein
an output of the rectification device is applied to a series circuit constituted by the series LED circuit and the current limiter, thereby to light each of the plurality of LED elements, and
a number of the plurality of LED elements is set in a manner that a voltage applied to the series LED circuit is 70 to 90% of an output voltage of the rectification device.

2. The lighting device of claim 1, wherein when an effective value of the output voltage of the rectification device is 100±10 V, the number of the plurality of LED elements comprised in the series LED circuit is set to 30 to 34.

3. The lighting device of claim 1, wherein
the device board comprises a base made of metal, an insulating layer layered on the base, and a plurality of metal layers layered on the insulating layer, with the plurality of metal layers electrically isolated from each other,
a plurality of LED element rows, each of which is constituted by a plurality of the LED elements connected in series with one another, are respectively mounted on the plurality of metal layers, and
the plurality of LED element rows and the plurality of metal layers are electrically connected to each other in a manner such that individual voltages which are applied to the plurality of LED element rows are respectively applied to the plurality of metal layers on which the plurality of LED element rows are mounted.

4. The lighting device of claim 3, wherein a number of the plurality of the LED elements constituting each of the plurality of LED element rows is set in a manner that the voltages respectively applied to the plurality of LED element rows are 30 V or less.

5. The lighting device of claim 3, wherein the number of the plurality of LED elements constituting each of the plurality of LED element rows is set in a manner that a voltage difference between each adjacent ones of the plurality of metal layers is 30 V or less.

6. The lighting device of claim 4, wherein the number of the plurality of LED elements constituting each of the plurality of LED element rows is set in a manner that a voltage difference between each adjacent ones of the plurality of metal layers is 30 V or less.

7. The lighting device of claim 2, wherein
the device board comprises a base made of metal, an insulating layer layered on the base, and a plurality of metal layers layered on the insulating layer, with the plurality of metal layers electrically isolated from each other,
a plurality of LED element rows, each of which is constituted by a plurality of the LED elements connected in series with one another, are respectively mounted on the plurality of metal layers, and
the plurality of LED element rows and the plurality of metal layers are electrically connected to each other in a manner such that individual voltages which are applied to the plurality of LED element rows are respectively applied to the plurality of metal layers on which the plurality of LED element rows are mounted.

8. The lighting device of claim 7, wherein a number of the plurality of the LED elements constituting each of the plurality of LED element rows is set in a manner that the voltages respectively applied to the plurality of LED element rows are 30 V or less.

9. The lighting device of claim 7, wherein the number of the plurality of LED elements constituting each of the plurality of LED element rows is set in a manner that a voltage difference between each adjacent ones of the plurality of metal layers is 30 V or less.

10. The lighting device of claim 8, wherein the number of the plurality of LED elements constituting each of the plurality of LED element rows is set in a manner that a voltage difference between each adjacent ones of the plurality of metal layers is 30 V or less.

11. A lighting device comprising:
a device board;
a rectification device connected to a commercial power supply;
a series LED circuit mounted on the device board and configured by connecting in series a plurality of LED elements; and
a current limiter which is connected in series with the series LED circuit and limits a maximum current flowing through the series LED circuit, wherein
an output of the rectification device is applied to a series circuit constituted by the series LED circuit and the current limiter, thereby to light each of the plurality of LED elements, and
a number of the plurality of LED elements is set in a manner that a forward LED element voltage applied to the series LED circuit is 70 to 90% of a rated input voltage of the commercial power supply.
